(19) United States
(12) Patent Application Publication
(10) Pub. No.: US 2004/0217196 A1
(43) Pub. Date: Nov. 4, 2004

(54) Apparatus for converting a showerhead to a handheld shower sprayer via quick connect/disconnect couplers

(76) Inventors: John Terry Yurek JR., Valencia, CA (US); David Robert Millar, Alido Viejo, CA (US)

Correspondence Address: John Terry Yurek Jr., 26504 BRYCE Road, Valencia, CA, 91254, US

(21) Appl. No.: 10/822,371

(22) Filed: Apr. 12, 2004

Related U.S. Application Data
(60) Provisional application No. 60/462,540, filed on Apr. 14, 2003.
(60) Provisional application No. 60/474,104, filed on May 29, 2003.

(51) Int. Cl. B05B 15/00

(52) U.S. Cl. 239/289

(57) ABSTRACT

The present invention provides a set of in-line couplers to quickly disconnect a showerhead from the water supply pipe and convert it to a handheld shower sprayer via a quick connect flexible conduit for purpose of cleaning, bathing and spraying. In first embodiment, a set of couplers includes a threaded female coupler that is fasten to water supply pipe's threaded end and a threaded male coupler that is fasten to showerhead threaded end. The showerhead can quickly be connected via the male coupler to female coupler at the water supply pipe. The showerhead can easily be disconnected and detached by push buttons on the side of female coupler. Furthermore, a flexible conduit is also provided to convert the detached showerhead to a handheld shower sprayer. The flexible conduit includes an elongated flexible water hose with two threaded ends. At one end of this hose, a male coupler is fastened and on the other end a female coupler is fastened thereof. This quick connect flexible conduit is coupled with the detached showerhead at one end and at the other end coupled with water supply. The quick connect/disconnect couplers may have optional integrated features such as anti scald mechanism to eliminate body injury caused by scalding, water flow regulator to regulate water pressure and a shut off valve to stop the water flow on demand.

Applicants claim priority-filling date for this application. Provisional applications filed on Apr. 14, 2003 & May 29, 2003, and the application numbers are 60/462,540 and 60/474,104.

### FIELD OF THE INVENTION

The present invention relates to in-line couplers for shower sprayer assembly. More particularly, the invention relates to quick connect/disconnect couplers that can quickly connect and disconnect showerhead from the water supply pipe for the purpose of redirecting water via quick connect/disconnect water hose.

### BACKGROUND OF THE INVENTION

The advantages of handheld shower sprayer for the purpose of bathing and cleaning is well known to the art. However, converting existing showerhead to a handheld shower sprayer in a quickest manner has been a challenge in this filed. Some prior art inventions disclosed such improvements via some attachments to water outlet and showerhead.

U.S. Pat. No. 5,624,073, issued to Muller et al, disclosed “a cleaning attachment system which can coupled between a water outlet and a showerhead. The system includes a diverter valve, flexible conduit, a coupling at a first end of the conduit for attaching the conduit in fluid communication with the diverter valve and a nozzle attached to a second end of the flexible conduit.”

Another U.S. Pat. No. 4,043,337, issued to Baugher, disclosed “a dental syringe attachment which includes a diverter valve attached in-line between a showerhead and a water supply pipe. The diverter valve includes a coupling for permanently attaching the dental syringe to the valve.”

In spite of the advantages of these devices in prior art, there are some limitations that can not be delivered for the purpose of productivity. For example, most systems are redirecting the water supply via a diverter valve, which is permanently attached to the showerhead, and the water supply pipe. That means the showerhead is affixed and can not be disconnected and therefore additional handheld sprayer is needed for this system.

However, this invention overcomes the shortcomings of prior invention and provides an in-line quick connect/disconnect showerhead to be used as a handheld shower sprayer via a quick connect/disconnect water hose to be used as extension for redirecting the water supply and its pressure.

### SUMMARY OF THE INVENTION

It is an object of the present invention to provide an in-line coupling system to quickly disconnect a showerhead and convert it to a handheld shower sprayer via a quick connect flexible conduit for the purpose of cleaning, bathing and spraying. In first embodiment, the in-line coupling system includes a threaded female coupler that is fasten to water supply pipe's threaded end and a threaded male coupler that is fastened to showerhead threaded end. The showerhead can quickly be connected via the male coupler to water supply pipe in which the female coupler is fastened for purpose of taking a shower. The showerhead can easily be disconnected and released by push buttons on the female coupler, which is fastened to water supply pipe. In this embodiment a flexible conduit is also provided to convert the disconnected showerhead to a handheld shower sprayer. The flexible conduit includes elongated flexible water hose with two threaded ends, a male coupler is fastened on one end of this hose and on the other end a female coupler is fastened. This quick connect flexible conduit is coupled with a showerhead at one end and on the other end coupled with water supply.

It is also an object of this invention to have couplers with optional integrated features such as anti scald mechanism to eliminate body injury caused by scalding, water flow regulator to regulate water pressure and a shut off valve to stop the water flow on demand.

It is another object of this invention to provide alternative embodiments of coupling system with respect to connect/disconnect features. Such embodiments can be reversible male and female couplers with respect to first embodiment of the present invention, push lock quick connect couplers and twisting lock quick connect couplers. All these embodiments have a correspondent flexible conduit like first embodiment for converting showerhead to shower sprayer.

Further objects and advantages of this invention will become apparent from consideration of the drawings and description that follows.

### BRIEF DESCRIPTION OF THE DRAWINGS

Exemplary embodiments of the invention will now be described in conjunction with the drawings in which:

FIG. 1 is a perspective of a showerhead assembly of the present invention showing with quick connect/disconnect couplers.

FIG. 2 is an exploded perspective view of FIG. 1.

FIG. 3 is a perspective of a showerhead assembly of the present invention showing with quick connect/disconnect couplers and a quick connect/disconnect flexible conduit.

FIG. 4 is a side exploded view of quick connect/disconnect couplers as shown in FIG. 1-3.

FIG. 5 is a cross sectional view taken along line 5-5 in FIG. 4.

FIG. 6 is an exploded perspective of threaded female coupler shown in FIG. 4-5.

FIG. 7 is a perspective view of anti-scald valve.

FIG. 8 is a perspective view of threaded female coupler in conjunction with anti-scald valve.

FIG. 9 is a perspective view of flow regulator valve.

FIG. 10 is a perspective view of threaded female coupler in conjunction with flow regulator valve.

FIG. 11 is a perspective view of threaded female coupler in conjunction with shutoff valve.

FIG. 12 is a perspective of the second embodiment of showerhead assembly of the present invention showing with quick connect/disconnect couplers.

FIG. 13 is an exploded perspective view of FIG. 12.

FIG. 14 is a perspective of the third embodiment of showerhead assembly of the present invention showing with quick connect/disconnect couplers.

FIG. 15 is an exploded perspective view of FIG. 14.

FIG. 16 is a side exploded view of quick connect/disconnect couplers as shown in FIG. 14-15.

FIG. 17 is an exploded perspective of threaded female coupler shown in FIG. 14-16.

FIG. 18 is a perspective of the fourth embodiment of showerhead assembly of the present invention showing with quick connect/disconnect couplers.

FIG. 19 is an exploded perspective view of FIG. 18.

FIG. 20 is a side exploded view of quick connect/disconnect couplers as shown in FIG. 18-19.

FIG. 21 is a cross sectional view taken along line 21-21 in FIG. 20.

FIG. 22 is an exploded perspective of threaded female coupler shown in FIG. 20-21.

### DETAILED DESCRIPTION OF THE INVENTION

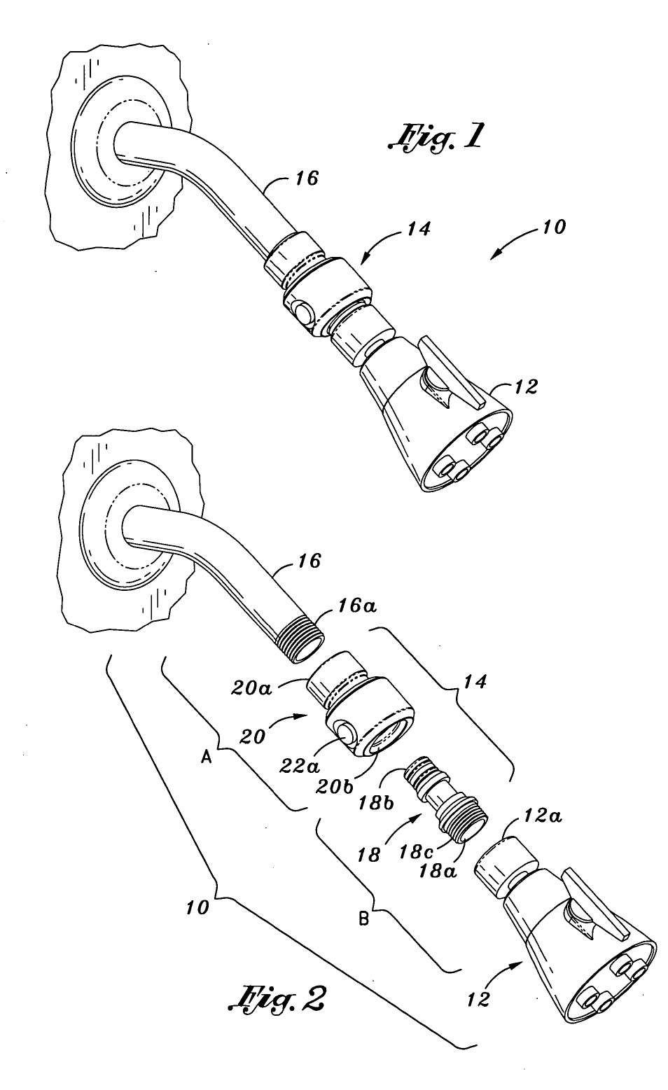

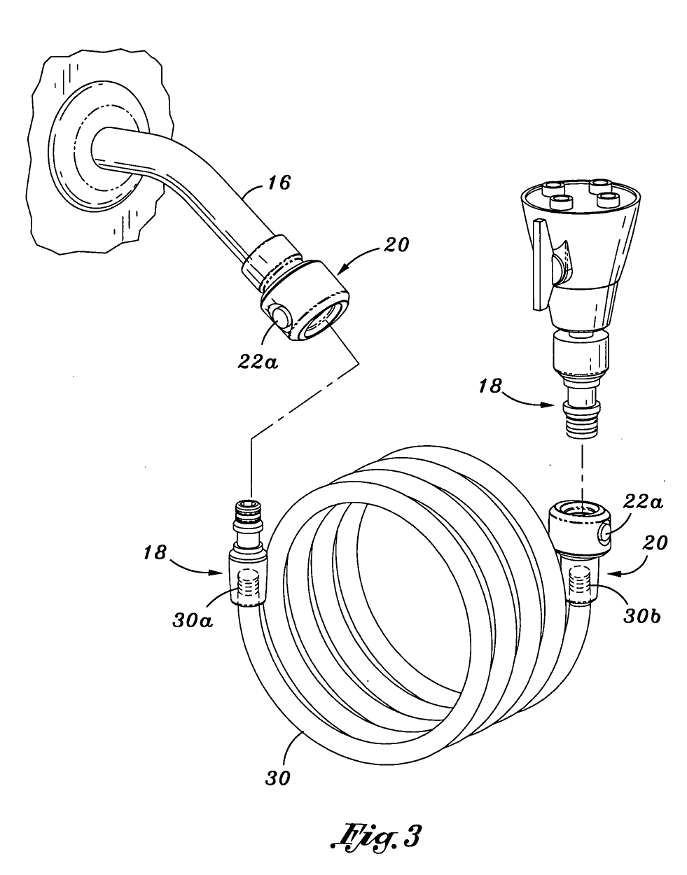

FIG. 1-6 showing the first embodiment of present invention which is a showerhead assembly 10 with quick connect/disconnect couplers 14 that connects water supply pipe 16 to a showerhead 12. The quick connect/disconnect couplers 14 utilize a system that the showerhead 12 can quickly be detached from the water supply pipe 16 for purpose of converting the showerhead 12 to a handheld shower sprayer by using a flexible conduit 30 as shown in FIG. 3. The set of couplers includes a threaded female coupler 20 and a threaded male coupler 18. These couplers are hollow and capable of passing water and its pressure from water supply pipe 16 to showerhead 12. The threaded female coupler 20 has a threaded end 20a that securely is fastened on threaded end 16a of water supply pipe 16. Therefore, the female coupler is permanently attached to water supply pipe 16, as it indicated by letter “A” in FIG. 2. The threaded male coupler 18 has also a threaded end 18c that is fastened to showerhead threaded end 12a. The reference “B” in FIG. 2 showing the male coupler is attached to showerhead as a unit.

In this embodiment, the male coupler 18 can be connected to the female coupler 20 by inserting the front end 18b that has o-rings 24 into the outlet passage 20b of female coupler 20. The front end 18b also has a shoulder edge 18e that engages with the inner flexible ring 22 and locks the couplers together. In order to release the male coupler from the female coupler, the push buttons 22a, 22b of the flexible ring 22 on the side of female housing must be pressed so the male coupler 18 can be released from the female coupler 20 and therefore showerhead and its male coupler can be detached from water pipe. The detached showerhead 18 then can be coupled with a flexible conduit 30 to be used as a shower sprayer for purpose of bathing, cleaning and spraying as illustrated in FIG. 3. The flexible conduit 30 includes a flexible water hose with two threaded ends 30a, 30b and a set of couplers similar to showerhead and water supply pipe couplers. This flexible conduit is used for quick connect/disconnect in conjunction with in-line couplers 14 for extending the showerhead 12 away from water pipe 16.

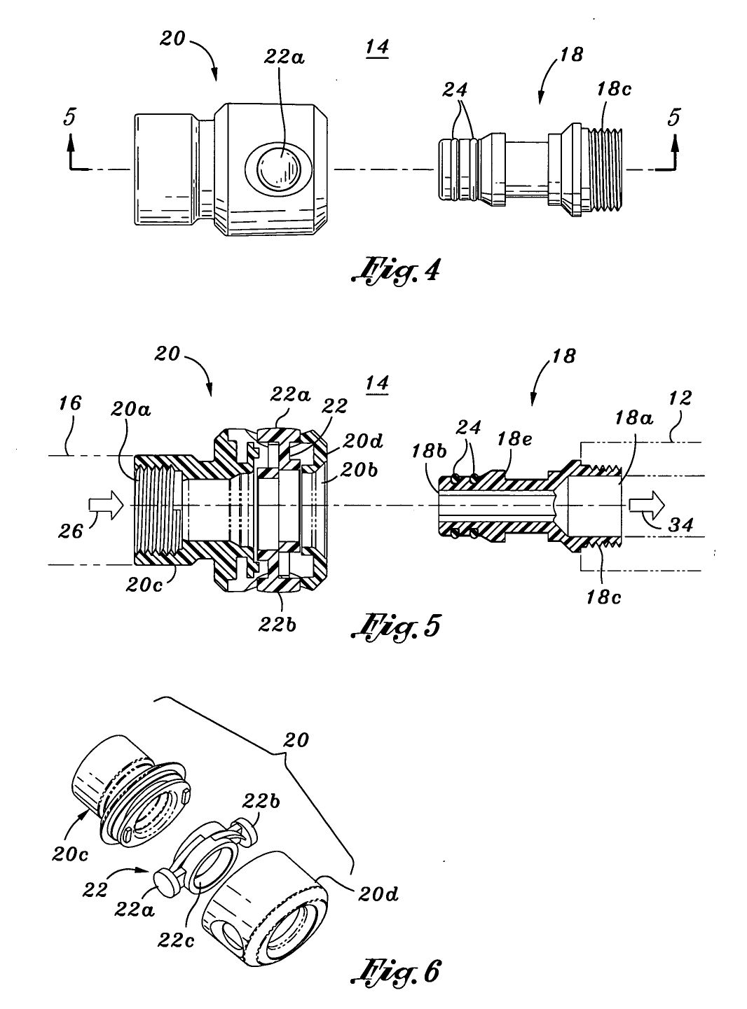

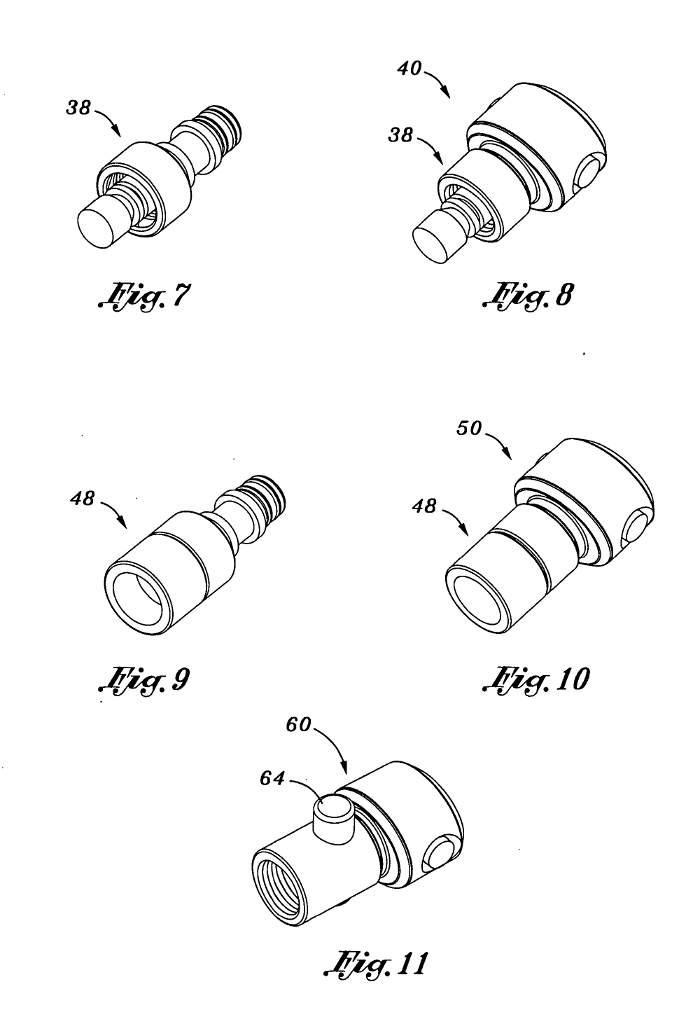

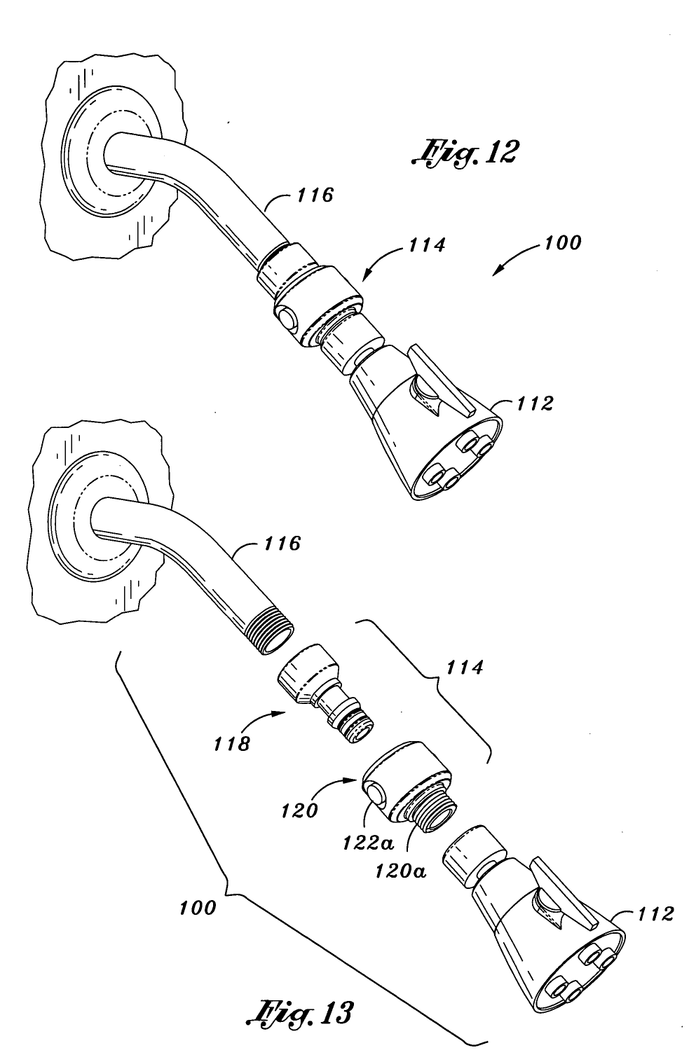

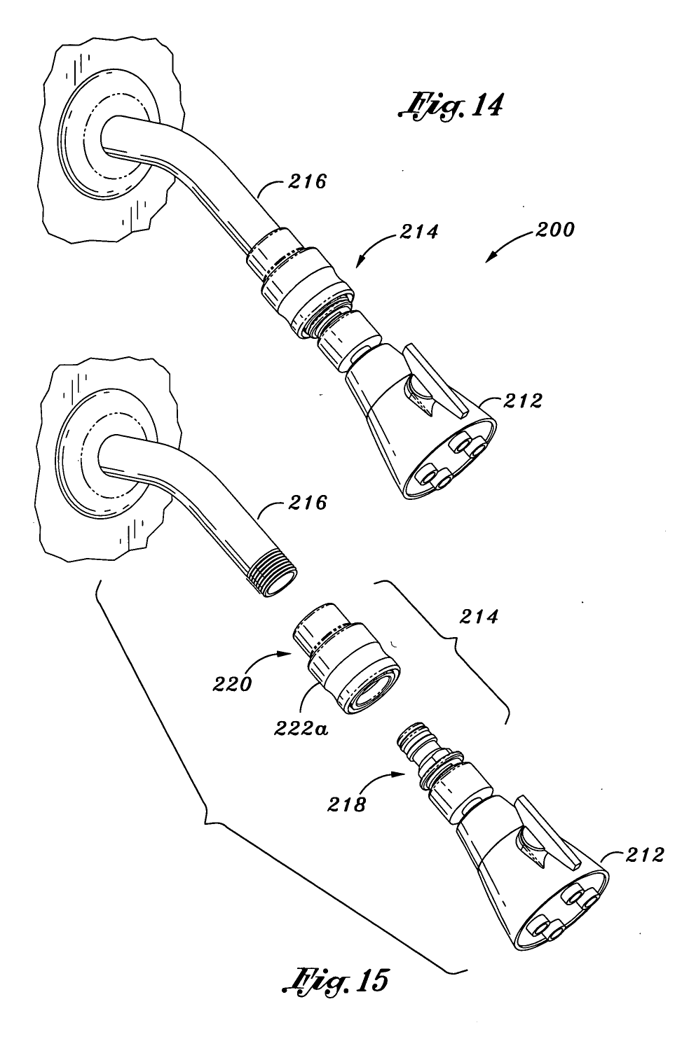

Referring to FIG. 4-5, a side and a cross sectional view of in-line couplers is shown as a first embodiment for this invention. The water flow 26 from water supply pipe 16 travels from female coupler inlet 26 and emerges at the other end of male coupler outlet 34 as illustrated in FIG. 5.

The threaded female coupler can be made of three main parts which includes a front pushbutton housing 20d, a flexible annular ring 22 that has buttons 22a, 22b at each opposite end, and the threaded end housing 20c. Furthermore, a modified-threaded female hosing 40 can integrate a scald mechanism 38 to prevent body injury from scalding as best shown in FIGS. 7 & 8. In another modified-threaded version of female coupler 50, a water flow regulator 48 can be integrated to regulate the water flow and its pressure as illustrated in FIGS. 9 & 10. Yet another modified version of female coupler 60 can have a shut off valve 64 to shut off the water flow on user's request as shown in FIG. 11. Although all the female coupler has been the subject of integration for these devices, but the invention is not limited to only one coupler. The integration of these devices can also be designed for male coupler as well.

The second embodiment of present invention is illustrated in FIGS. 12 & 13. In this embodiment, a showerhead assembly 100 has a set of quick connect/disconnect couplers 114 that is connected in-line with water supply pipe 116 and showerhead 112. The attached couplers 114 are similar to first embodiment but reversed in position. The threaded male coupler 118 is now attached to water pipe 116 and the threaded female coupler 120 attached to showerhead 112 and the mechanism is very much similar to first embodiment.

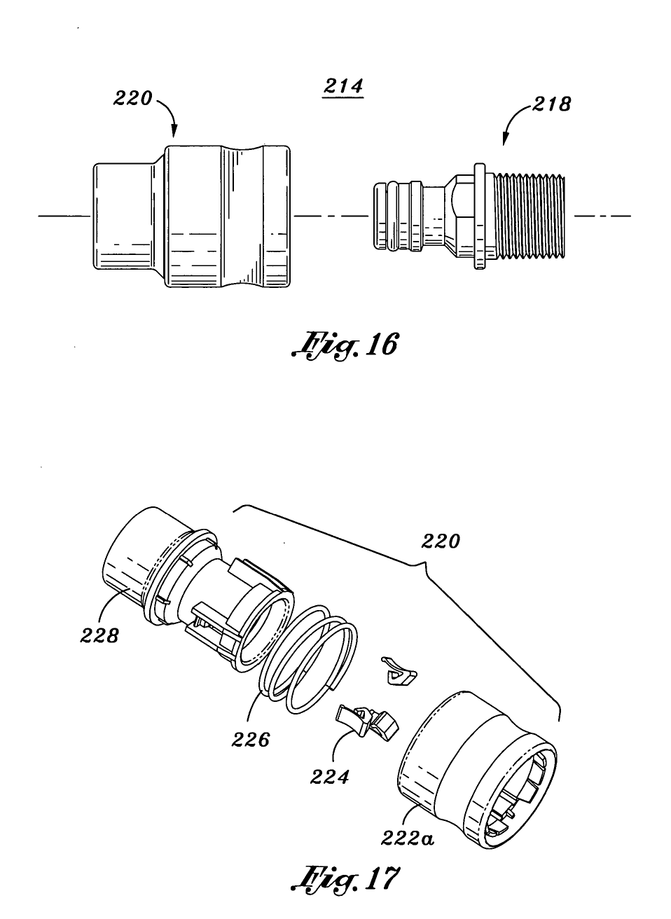

The third embodiment of present invention is illustrated in FIG. 14-17. In this embodiment, a showerhead assembly 200 has a set of quick connect/disconnect couplers 214 that is connected in-line with water supply pipe 216 and showerhead 212. The attached couplers 214 are similar to first embodiment except the female coupler 220 that connects to water supply pipe 216 has a slider sleeve 222a that pullback to release the male coupler 218. Therefore the mechanism is different with respect to first embodiment. In this embodiment, the female coupler has a main body 228, a coil spring 226, a plurality of moveable locking pins 224 and a slider sleeve 222a. Like first embodiment, all embodiments include a flexible conduit with similar type couplers that used in showerhead assembly for extending and converting the showerhead.

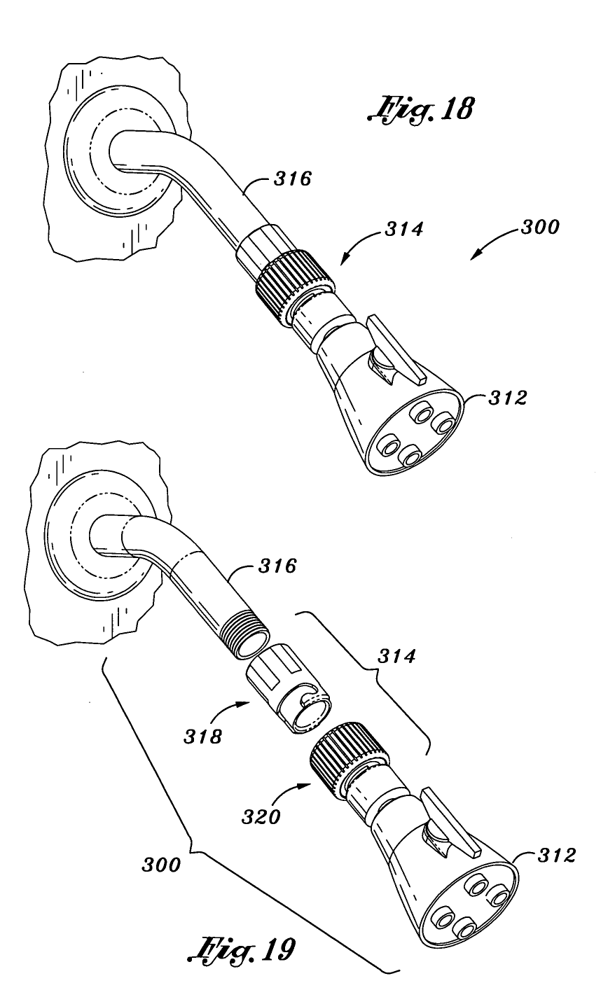

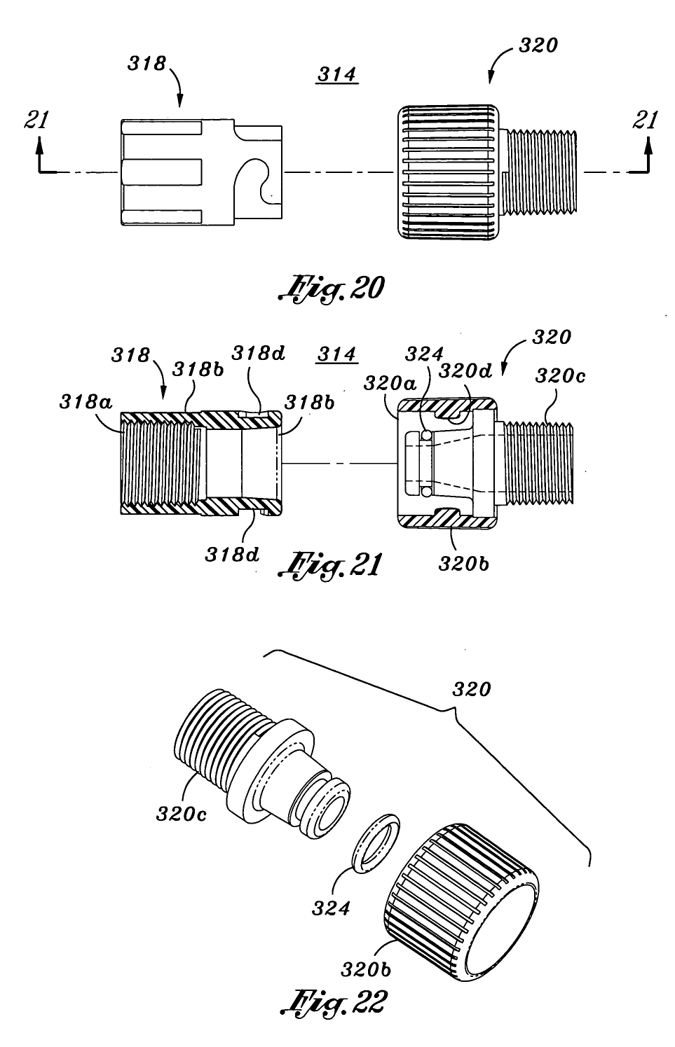

Referring to FIG. 18-22, a fourth embodiment of the present invention is disclosed. In this embodiment, a showerhead assembly 300 has a set of quick connect/disconnect couplers 314 that is connected in-line with water supply pipe 316 and showerhead 312. The attached couplers 314 are similar to second embodiment except the female coupler 320 that connects to showerhead 316 has a twisting cap 320 that twist on/off to connect/disconnect to the male coupler 318. The twist cap 320b of the female coupler 320 has a couple of projected tabs 320d which engages with matting recess cavity 318d which is located on male coupler 318 exterior surface to lock as the twist cap is rotated 90 degrees clockwise in motion. In order to unlock the matting couplers the cap must twist counter clockwise. Furthermore, the threaded female coupler has a main body 320c that is threaded at one end and on the other end has a groove that O-ring 324 nested in that groove.

While this invention is susceptible of embodiments in many different forms, this specification and the accompanying drawings disclose only some specific forms as examples of the invention. The invention is not intended to be limited to the embodiments so described, however, the scope of the invention is pointed out in the appended claims.

We claim:

1. An apparatus for quickly converting a showerhead to a handheld shower sprayer comprising:
a water supply pipe, said pipe has a threaded fastener at one end;
a showerhead, said showerhead having a threaded fastener at one end;
a set of in-line couplers, said couplers includes a threaded female coupler that is connected to said water supply threaded end, and a threaded male coupler that is connected to said showerhead threaded end; and,
means to quickly connect/disconnect said male coupler which is fasten to said showerhead from said female coupler which is fasten to said water supply pipe.

2. An apparatus for quickly converting a showerhead to a handheld shower sprayer according to claim 1, furthermore includes a flexible conduit, said flexible conduit includes a flexible hose connected to similar type of said male coupler and said female coupler at each ends of said flexible hose, said flexible conduit provides extension for connecting said showerhead to said water supply pipe via its quick connect/disconnect said couplers.

3. An apparatus for quickly converting a showerhead to a shower sprayer according to claim 1, wherein said means to quickly connect/disconnect said male coupler to said female coupler can be via pushbutton lock/unlock mechanism.

4. An apparatus for quickly converting a showerhead to a handheld shower sprayer according to claim 1, wherein said means to quickly connect/disconnect said male coupler to said female coupler can be via twist motion lock/unlock mechanism.

5. An apparatus for quickly converting a showerhead to a handheld shower sprayer according to claim 1, wherein said means to quickly connect/disconnect said male coupler to said female coupler can be via forward push to lock and unlock it via pullback mechanism.

6. An apparatus for quickly converting a showerhead to a handheld shower sprayer according to claim 1, wherein said threaded female coupler have integrated anti scald mechanism.

7. An apparatus for quickly converting a showerhead to a handheld shower sprayer according to claim 1, wherein said threaded female coupler have integrated flow regulator mechanism.

8. An apparatus for quickly converting a showerhead to a handheld shower sprayer according to claim 1, wherein said threaded female coupler have integrated shutoff valve.

9. An apparatus for quickly converting a showerhead to a handheld shower sprayer comprising:
a water supply pipe, said pipe has a threaded fastener at one end;
a showerhead, said showerhead having a threaded fastener at one end;
a set of in-line couplers, said couplers includes a threaded male coupler that is connected to said water supply threaded end, and a threaded female coupler that is connected to said showerhead threaded end; and,
means to quickly connect/disconnect said female coupler which is fasten to said showerhead from said male coupler which is fasten to said water supply pipe.

10. An apparatus for quickly converting a showerhead to a handheld shower sprayer according to claim 9, furthermore includes a flexible conduit, said flexible conduit includes a flexible hose connected to similar type of said female coupler and said male coupler at each ends of said flexible hose, said flexible conduit provides extension for connecting said showerhead to said water supply pipe via its quick connect/disconnect said couplers.
